(19) United States
(12) Patent Application Publication
(10) Pub. No.: US 2026/0038751 A1
(43) Pub. Date: Feb. 5, 2026

(54) LIGHT FILTERED MULTICHARACTER KEYCAPS OF A BACKLIT KEYBOARD

(71) Applicant: LENOVO ENTERPRISE SOLUTIONS (SINGAPORE) PTE LTD., SINGAPORE (SG)

(72) Inventors: CONNOR J. RAINES, RALEIGH, NC (US); TINASHE KUCHERERA, RALEIGH, NC (US); LAKE MAXWELL, CAPE CARTERET, NC (US); JEFFREY S. HOLLAND, MORRISVILLE, NC (US)

(21) Appl. No.: 18/790,641

(22) Filed: Jul. 31, 2024

(51) Int. Cl. H01H 13/83; H01H 9/18; H01H 13/70

(52) U.S. Cl. CPC H01H 13/83; H01H 9/182; H01H 2009/186; H01H 13/7006; H01H 2219/039; H01H 2219/054; H01H 2219/062

(57) ABSTRACT

Systems and apparatus for controlling light emitted from light sources that backlight multicharacter keycaps, resulting in different characters being displayed on the keycaps. A system may include: a processor, and a keyboard having one or more backlit keyboard keys, where at least one of the one or more backlit keyboard keys includes: a socket comprising a light source, and a keycap coupled to the socket. The keycap may include: a first color filter corresponding to a first character, where the first character is displayed on the keycap when a color of light emitted from the light source matches the first color filter, and a second color filter corresponding to a second character, where the second character is displayed on the keycap when the color of the light emitted from the light source matches the second color filter.

### BACKGROUND

### Field of the Disclosure

The field of the disclosure is keyboards, or, more specifically, methods, apparatus, and systems for light filtered multicharacter keycaps of a backlit keyboard.

### Description of Related Art

Keyboards typically have one character displayed on each key, or at most two characters displayed at the same time on each key. Some keyboards use screens on the keys to change what character each key is displaying. However, these keyboards are considerably expensive when compared to standard keyboards. It would be beneficial to provide a keyboard with the capability of changing what character is displayed on the keys without relying on expensive screens.

### SUMMARY

Methods, systems, and apparatus for light filtered multicharacter keycaps of a backlit keyboard according to various embodiments are disclosed in this specification. In accordance with one aspect of the present disclosure, a method of changing the character on a key includes receiving an input, and changing a color of a light backlighting a keyboard key from a first color to a second color, including changing a displayed character on the keyboard key from a first character corresponding with the first color to a second character corresponding to the second color.

In accordance with another aspect of the present disclosure, light filtered multicharacter keycaps of a backlit keyboard may include a system including: a processor, and a keyboard having one or more backlit keyboard keys, where at least one of the one or more backlit keyboard keys includes: a socket comprising a light, and a keycap coupled to the socket, where the keycap includes: a first color filter corresponding to a first character, where the first character is displayed on the keycap based on a color of the light matching the first color filter, and a second color filter corresponding to a second character, where the second character is displayed on the keycap based on the color of the light matching the second color filter.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 shows an example line drawing of a light filtered multicharacter keycap of a backlit keyboard in accordance with embodiments of the present disclosure.

FIG. 2 shows an example line drawing of another light filtered multicharacter keycap of a backlit keyboard in accordance with embodiments of the present disclosure.

FIG. 3 shows an example line drawing of another light filtered multicharacter keycap of a backlit keyboard in accordance with embodiments of the present disclosure.

FIG. 4 shows an example system configured for changing the character of a light filtered multicharacter keycap of a backlit keyboard according to some embodiments of the present disclosure.

FIG. 5 is a flowchart of an example method for changing the character of a light filtered multicharacter keycap of a backlit keyboard according to some embodiments of the present disclosure.

FIG. 6 is a flowchart of an example method for changing the character of a light filtered multicharacter keycap of a backlit keyboard according to some embodiments of the present disclosure.

FIG. 7 shows an example line drawing of a light filtered multicharacter keycap of a backlit keyboard in accordance with embodiments of the present disclosure.

### DETAILED DESCRIPTION

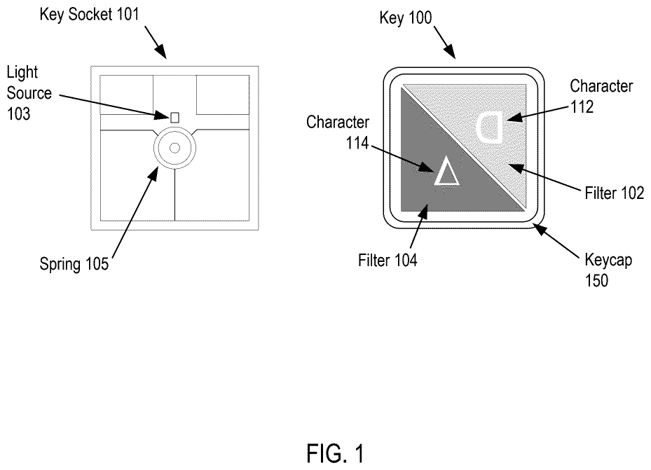

Exemplary methods, systems, and products for light filtered multicharacter keycaps of a backlit keyboard in accordance with the present disclosure are described with reference to the accompanying drawings, beginning with FIG. 1. FIG. 1 sets forth an example line drawing of a light filtered multicharacter keycap of a backlit keyboard in accordance with embodiments of the present disclosure. FIG. 1 shows an underside of an example multicharacter keycap that has been taken off of a keyboard, as well as showing the underlying key socket of the keyboard. Specifically, FIG. 1 includes a key socket 101 and a key 100.

The example key socket 101 of FIG. 1 is included as part of the keyboard and is configured to couple to the key 100. The example key socket 101 includes a spring 105 and a light source 103. The spring 105 is configured to return the key 100 back to its original position after the key has been pressed. The light source 103 is configured to backlight the key, allowing the character on the exterior surface of the key to be viewable in low-light environments. The light source 103 may be an LED (light emitting diode) that emits visible light and may be a color-configurable light, such as an RGB LED light. A typical RGB LED light has 3 LEDs (one red, one green, and one blue), and may be configured to change to emitting any visible color of light based on user input or other system or keyboard configurations. The key 100 also includes electrical conductors and/or components that are not shown in FIG. 1 and that are used to sense an actuation of the key 100 (e.g., electrical contacts that permit the flow of current once the key 100 is pressed by a user).

The example key 100 of FIG. 1 is configured to couple to the key socket 101 of a keyboard. In FIG. 1, the underside of the key 100 is shown for further explanation. The example key 100 includes a keycap 150, which includes the exterior surface of the key 100 that is visible to a user of the keyboard. The example key 100 of FIG. 1 is configured to show one of two different characters (such as character 112, depicting a “D”; and character 114, depicting a “A” or ‘capital delta’). The key 100 also includes two light filters (such as filter 102 and filter 104) positioned on the underside of the keycap, with each filter corresponding to a different character. In the embodiment of FIG. 1, filter 102 is positioned under character 112 while filter 104 is positioned under character 114 of the key 100. Each respective character may be formed as a transparent portion of the keycap in the pattern of the respective character, so that light shining through the keycap 150 (coming from the light source 103 in the key socket 101) allows the respective character to be viewable by a user of the keyboard.

The filters 102 and 104 of FIG. 1 may be configured as different light filters. In one embodiment, the filters are color filters, where filter 102 filters a different color of light from filter 104. For example, filter 102 may only allow red light to pass through the filter while filter 104 may only allow blue light to pass through the filter. In such an example, the light source 103 may be configured to change between emitting light of different visible colors (e.g., changing from emitting light having a first visible color to light having a second visible color) to select which character is visible on the exterior surface of the key 100. Continuing with the above example, when the light source 103 is emitting red light, only filter 102 will allow light to pass through the key (since filter 104 only allows blue light and therefore blocks the red light), causing character 112 to be displayed on the surface of the key 100. Alternatively, when the light source 103 is emitting blue light, only filter 104 will allow light to pass through the key (since filter 102 only allows red light and therefore blocks the blue light), causing character 114 to be displayed on the surface of the key 100. In such an example, green light emitted from the light would prevent any character from being viewable on the key, and a colored light that is a combination of the two filter colors (such as purple, which is made using both the red and blue lights together) would display both characters simultaneously. In such an example, the light source 103 may be altered to control which character is being displayed on the key.

By making the light source 103 controllable by a user of the keyboard, a user may selectively configure which characters are displayed on specific keys of the keyboard. Such an embodiment allows for such customization features without relying on expensive screens under the keys and instead relying on existing lights positioned under the keyboard keys. For example, a user could swap out the standard keyboard keys with a set of color filtered keys to convert an existing keyboard into a customizable keyboard, as described above. In another embodiment, the filters could be different polarizing light filters and the light under the keys could be configured to emit different types of polarized light corresponding to the filters to provide the same effect as described above.

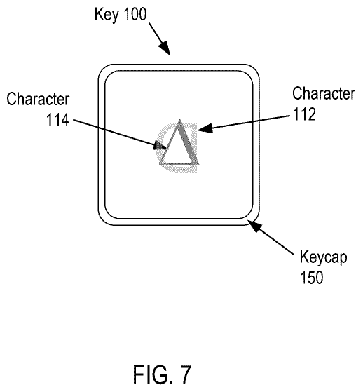

In the example of FIG. 1, the two characters are positioned separately from one another such that the characters are spaced apart from one another. In another embodiment (shown in FIG. 7), the key may be configured so that the characters are superimposed, with both characters being positioned in the middle of the key. In such an embodiment, each character comprises a different filter color. In such an embodiment, any portion of the key where the characters are superimposed would be transparent without a color filter, so that that portion of each key would be visible independent of which character is being displayed. In such an example, the key is configured to change which character is being displayed on the key without changing the position of the character on the surface of the key.

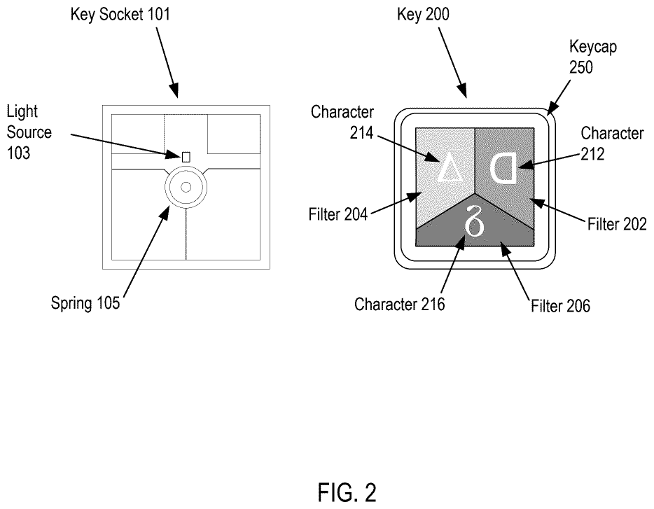

For further explanation, FIG. 2 sets forth an example line drawing of another light filtered multicharacter keycap of a backlit keyboard in accordance with embodiments of the present disclosure. FIG. 2 differs from FIG. 1 in that the key 200 of FIG. 2 is configured with the option of selecting between three different characters for display on the exterior surface of the key 200 (instead of two different characters, like the key 100 of FIG. 1).

The example key 200 of FIG. 2 is configured to show one of three different characters (such as character 212, depicting a “D”; character 214, depicting a “Δ” or ‘capital delta’; and character 216, depicting a “δ” or ‘lowercase delta’). The key 200 also includes three light filters (such as filter 202, 204, and filter 206) positioned on the underside of the keycap, with each filter corresponding to a different character. In the embodiment of FIG. 2, filter 202 is positioned under character 212, filter 204 is positioned under character 214, and filter 206 is positioned under character 216 of the key 200. Each respective character may be formed as a transparent portion of the keycap in the pattern of the respective character, so that light shining through the keycap 250 (coming from the light source 103 in the key socket 101) allows the respective character to be viewable by a user of the keyboard.

In one example embodiment, similar to the example as described above in reference to FIG. 1, the filters of key 200 may be different color filters. For example, filter 202 may only allow red light to pass through, filter 204 may only allow blue light to pass through, and filter 206 may only allow green light to pass through. In such an example, when the light source 103 is emitting red light, only filter 202 will allow light to pass through the key, causing character 212 to be displayed on the surface of the key 200. When the light source 103 is emitting blue light, only filter 204 will allow light to pass through the key, causing character 214 to be displayed on the surface of the key 200. Similarly, when the light source 103 is emitting green light, only filter 206 will allow light to pass through the key, causing character 216 to be displayed on the surface of the key 200. In such an example, the light may be altered to control which character is being displayed on the key. The characters of key 200 may be any different characters. In one embodiment, the characters may correspond to a similar letter but from different alphabets (such as the example of FIG. 2). In another example, the different characters of a single key may be unrelated to one another. In another example, each character of a single key may correspond with a different alphabet. In another example, each character of the key may be the same character but in a different capitalization (such as characters 214 and 216 in the example of FIG. 2).

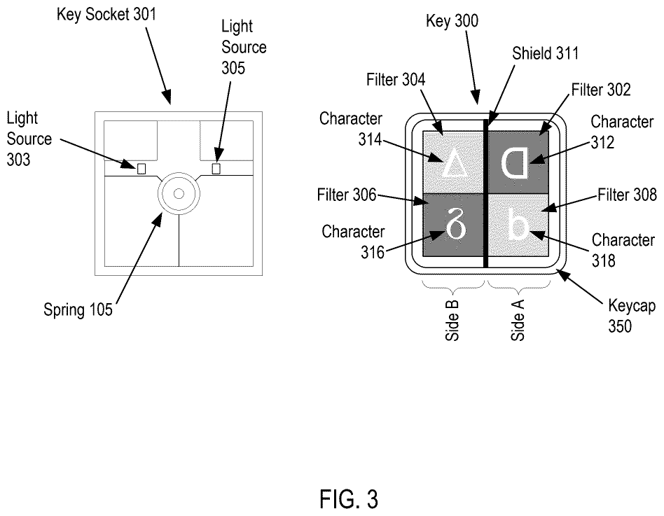

For further explanation, FIG. 3 sets forth an example line drawing of another light filtered multicharacter keycap of a backlit keyboard in accordance with embodiments of the present disclosure. FIG. 3 differs from FIG. 1 in that the key 300 of FIG. 3 is configured with the option of selecting between four different characters for display on the exterior surface of the key 300 (instead of two different characters, like the key 100 of FIG. 1). In the example of FIG. 2, the key provides three different filters for selectively displaying three different characters on a single key. However, in the case when using color filters, using more than the three color filters (such as the primary colors of red, green, and blue) would cause multiple characters to be displayed at once based on the particular light being selected. For example, a light showing a color besides red, green, or blue would allow light to pass through at least two filters at once, preventing the key from allowing four different distinct characters to be individually displayed on the key. The key 300 of FIG. 3 therefore may include a shield 311 under the key 300 that may separate multiple different filters included in the exterior surface of the key 300.

The shield 311 that divides the underside of the key 300 into two sides (namely, side A and side B). Side A of the key 300 is configured to show one or more of two different characters (such as character 312, depicting a capital “D”; and character 318, depicting a lowercase “d”). Side A of the key 300 also includes two light filters (such as filter 302 and filter 308) positioned on the underside of the keycap, with filter 302 positioned under character 312, and filter 308 positioned under character 318. Side B of the key 300 is configured to show one or more of two different characters different from the two characters on side A (such as character 314, depicting a “Δ” or ‘capital delta’; and character 316, depicting a “δ” or ‘lowercase delta’). Side B of the key 300 also includes two light filters (such as filter 304 and filter 306) positioned on the underside of the keycap, with filter 304 positioned under character 314, and filter 306 positioned under character 316. Each respective character may be formed as a transparent portion of the keycap in the pattern of the respective character, so that light shining through the keycap 350 allows the respective character to be viewable by a user of the keyboard.

The example key socket 301 of FIG. 3 differs from the key socket 101 of FIG. 1 in that the key socket 301 of FIG. 3 includes two different lights (such as light source 303 and light source 305). When the key 300 is coupled to the key socket 301, light source 303 is positioned under side A of the key 300 and light source 305 is positioned under side B of the key 300. The shield 311 of the key 300 blocks light from light source 303 from reaching the filters on side B of the key, and also blocks light from light source 305 from reaching the filters on side A of the key. Accordingly, by controlling which light (light source 303 or light source 305) is on, and by selecting which color that light is emitting, a user may be able to select between four different characters on a single key. By having one or both lights on, and depending on the color emitting from each light, any number of the four different keys could be displayed simultaneously. In another embodiment (not shown in FIG. 3), a key could have three different filters on each side of the shield, allowing such a key to display one or more of six different characters for a single key. Including additional lights or shield would allow for an even larger number of characters for a single key.

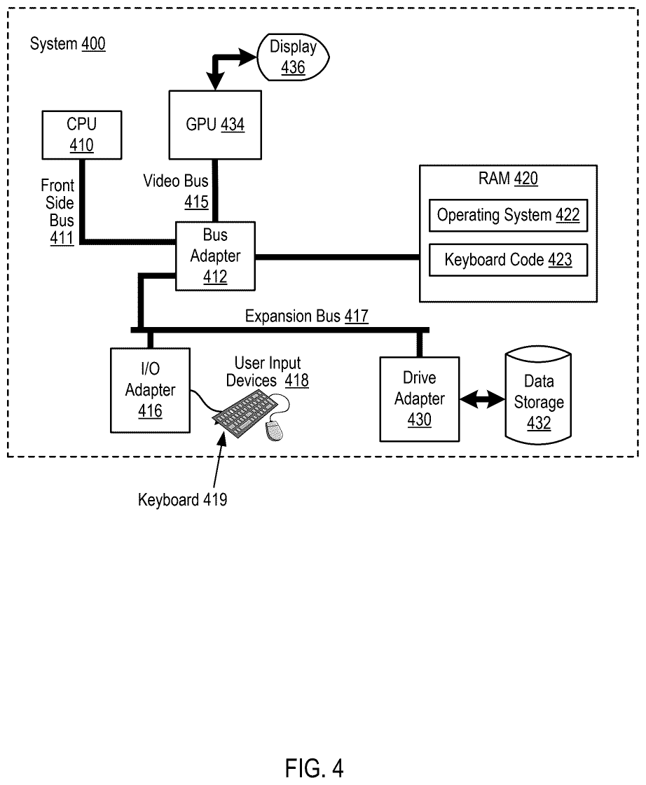

For further explanation, FIG. 4 sets forth an example system configured for changing the character of a light filtered multicharacter keycap of a backlit keyboard in accordance with embodiments of the present disclosure. The example system 400 of FIG. 4 includes multiple processors, such as a CPU (central processing unit) 410, a GPU 434 (graphics processing unit), and others not depicted in FIG. 4. The example system 400 may also include RAM (random access memory) 420 which is connected through a high speed memory bus and bus adapter 412 to CPU 410 and to other components of the system 400. The examiner processor (such as CPU 410) is configured to receive a signal from the first keyboard key and recognize the signal as the first character when the visible color of light emitted by the light source matches the first color filter, and as the second character when the visible color of light emitted by the light source matches the second color filter.

Stored in RAM 420 is an operating system 422 and keyboard code 423. Operating systems useful in computers configured for changing the character of a light filtered multicharacter keycap of a backlit keyboard according to embodiments of the present disclosure include UNIX™, Linux™, Microsoft Windows™, AIX™, and others as will occur to those of skill in the art. The operating system 422 in the example of FIG. 4 is shown in RAM 420, but many components of such software typically are stored in non-volatile memory also, such as, for example, on data storage 432, such as a disk drive.

The system 400 of FIG. 4 includes disk drive adapter 430 coupled through expansion bus 417 and bus adapter 412 to CPU 410 and other components of the system 400. Disk drive adapter 430 connects non-volatile data storage to the system 400 in the form of data storage 432. Disk drive adapters useful in computers configured for inserting sequence numbers into editable tables according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented as an optical disk drive, Flash drive, electrically erasable programmable read-only memory (‘EEPROM’), RAM drives, and so on, as will occur to those of skill in the art.

The example system 400 of FIG. 4 includes one or more input/output (′I/O′) adapters 416. I/O adapters implement user-oriented input/output through, for example, software drivers and computer hardware for controlling output to display devices such as computer display screens, as well as user input from user input devices 418 such as keyboards (such as keyboard 419) and mice. The example system 400 of FIG. 4 includes a GPU 434, which is an example of an I/O adapter specially designed for graphic output to a display device 436 such as a display screen or computer monitor. GPU 434 is connected to CPU 410 through a high speed video bus 415, bus adapter 412, and the front side bus 411, which is also a high speed bus.

In the example keyboard code 423 of FIG. 4 is configured to control the keyboard 419 coupled to the system 400. Specifically, the keyboard 419 may include one or more keys similar to the keys depicted in FIG. 1-4, and the keyboard code 423 may be configured to select which characters are displayed on each of the keys of the keyboard by selecting which backlighting lights are on and what color they emit under each key. Such a determination of what characters are being displayed may be based on various different triggers. Some examples of such triggers may include a keyboard shortcut, specific commands in the software of the system 400 (such as a user interface where a user may customize the layout of the keyboard), a particular application opening, certain activity within an application (such as changing a language within an application), and the like. For example, changing a language in a web browser from English to Chinese (e.g., Simplified Chinese) could trigger the keyboard code to change the keys of the keyboard 419 from the English alphabet to the Chinese alphabet (e.g., Simplified Chinese). In another example, a user may open a spreadsheet application and a portion of the keys may change to a set of mathematical symbols.

The keyboard code 423 of FIG. 4 may be configured to change all of the keys, a portion of the keys, or a single key within the keyboard. The keyboard code may also be configured to display multiple specific characters for one or more keys. In one embodiment, the keyboard may display two characters on a key, where one of the characters is the primary character and the other character is a secondary character. In such an embodiment, the primary character may be selected each time the key is pressed while the secondary character is selected each time the key is pressed in combination with a second key (such as the shift key, or any other key programable by a user via the keyboard code). Each trigger may be user customizable and may determine which number of keys have their character changed and to which character.

In one embodiment, the keyboard is configured to communicate to the system, such as with the keyboard code 423, which specific characters each key of the keyboard are configured to selectively display. For example, the keyboard may inform the keyboard code which alternative alphabets, characters, character encodings, or the like (or any other alternative characters) are available for display by the keyboard, so that the keyboard code can effectively determine which triggers to set as active and which characters to display for each trigger. In another embodiment, the keyboard code may be informed, based on user input, which alternative characters the keys of the keyboard are configured to display.

In one embodiment, holding down a keyboard shortcut, which may be selected by a user (such as holding down the shift key and the alt key), may temporarily change the characters of one or more of the keys while the shortcut is being held down, and thus also change in a corresponding manner the values or symbols that are recognized from a keypress of the one or more changed keys. For example, a user may configure the keyboard code to cause all of the English alphabet keys in the keyboard 419 to change (both the display and the corresponding recognized value or symbol) to the characters of the Chinese alphabet while a keyboard shortcut (such as the shift key and the function key) are being held down. In such an example, a user may hold down the shortcut to view all of the Chinese alphabet characters on the keyboard, and then select the Chinese alphabet characters while still holding down the shortcut. Then, once the user releases the keyboard shortcut keys, the characters of the keyboard will return or revert to their original English alphabet characters (along with the values or symbols recognized from a keypress of the reverted keys changing as well). In such an example, a user is able to program a keyboard shortcut to visually select a variety of alternative keys without having to permanently change the characters of the keyboard.

In one embodiment, multiple different keyboard shortcuts may be selected to temporarily display various combinations of different alternative keys for one or more keys of the keyboard. In another embodiment, a keyboard shortcut may be selected to permanently switch the keys of the keyboard to an alternative set of characters. For example, a specific keyboard shortcut may be programed (using the keyboard code) to allow a user to quickly switch the keyboard between various alphabets.

In the example of FIG. 4, the keyboard code 423 is shown as being included within the computer or system which the keyboard is coupled to. In another embodiment, the keyboard code 423 is instead included within the keyboard itself, for example as firmware. That is, a ‘smart’ keyboard with the software built in may be coupled to any computer or system without having to add the keyboard code to the system.

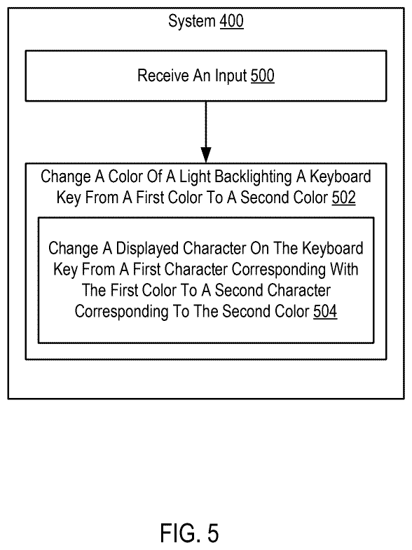

For further explanation, FIG. 5 sets forth a flowchart of an example method for changing the character of a light filtered multicharacter keycap of a backlit keyboard according to some embodiments of the present disclosure. The method of FIG. 5 includes receiving 500 an input. Receiving 500 an input may be carried out by the system 400 of FIG. 4 (such as by the keyboard code included in the system) receiving any input that is configured to trigger or programmed to trigger a character change in the keyboard. For example, the keyboard code may receive an input, such as a keyboard shortcut from a user. In another example, the input received may be a particular application opening. In another example, receiving the input includes receiving an indication that a software application has been triggered, where the second color is determined based on the triggered software application.

The method of FIG. 5 also includes changing 502 a color of a light backlighting a keyboard key from a first color to a second color. Changing 502 the color of a light backlighting a keyboard key may be carried out by system 400 (or by the keyboard code) sending an instruction to the keyboard to change the color of a particular key. Such an instruction may include the one or more keys for which the light should be changed, which color the light should change to, and a duration of how long to change the light. Different received inputs may cause a different key to be displayed for a particular key. Changing a color of a light emitted by a backlight includes also changing 504 a displayed character on the keyboard key from a first character corresponding with the first color to a second character corresponding to the second color. For example, and with reference to the key 100 of FIG. 1, the system may receive an input of a keyboard shortcut and, in response to the input, change the color of the backlighting light emitted by the light source 103 under the ‘D’ key 100 from red to blue, which in turn (based on the color filters 102 and 104 included in the keyboard key 100) changes the character being displayed by the key from the ‘D’ character to the “A” or ‘capital delta’ character.

In one embodiment, such a key character change may be a toggled or stable change (such as until another input is received that triggers an instruction for the keyboard to change the key back to the ‘D’ character). In another embodiment, such a change may be a temporary change (such as changing the character being displayed only while the keyboard shortcut is held down, or only for a specified duration or amount of time). The system is configured to, any time a displayed character of a key is changed to an alternative character, also change the user input received from a keypress that key to match the alternative character displayed on the key. For example, changing the character displayed on the key also correspondingly changes the value or symbol that will be recorded when that key is pressed by a user.

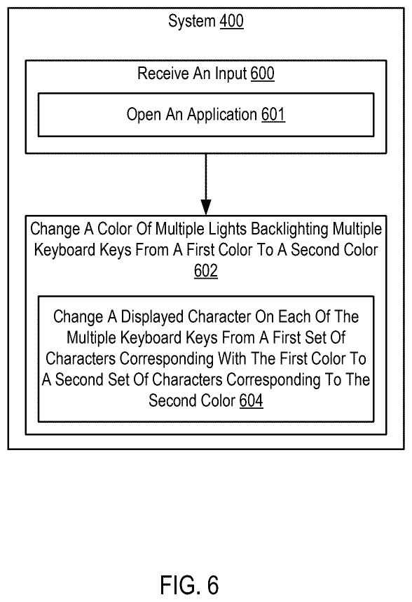

For further explanation, FIG. 6 sets forth a flowchart of another example method for changing the character of a light filtered multicharacter keycap of a backlit keyboard according to some embodiments of the present disclosure. The method of FIG. 6 includes receiving 600 an input. Receiving 600 an input may be carried out by the system 400 of FIG. 4 (such as by the keyboard code included in the system) receiving any input programmed to trigger a character change in the keyboard. Receiving 500 an input includes opening 601 an application. For example, the input received may be a particular application, such as browser application, opening in the system.

The method of FIG. 6 also includes changing 602 a color of multiple lights backlighting multiple keyboard keys from a first color to a second color. Changing 602 a color of multiple lights backlighting multiple keyboard keys may be carried out by system 400 (or by the keyboard code) sending an instruction to the keyboard to change the color of a particular set of key. Such an instruction may identify the multiple keys for which the light should be changed, which color the light should change to, and a duration of how long to change the light. Changing 602 a color of multiple lights backlighting multiple keyboard keys includes also changing 604 a displayed character on each of the multiple keyboard keys from a first set of characters corresponding with the first color to a second set of characters corresponding to the second color. For example, the system may receive an input of a browser application opening and, in response to the input, change the color of the keys having characters of the English alphabet from red to blue, which in turn (based on the color filters included in the keyboard keys) changes the character set being displayed by the keys from the characters of the English alphabet or language to the characters of a different alphabet or language (such as an alphabet corresponding to the default language setting for the browser application).

In view of the explanations set forth above, readers will recognize that some, but not all, of the benefits of changing the character of a light filtered multicharacter keycap of a backlit keyboard according to embodiments of the present disclosure may include:
Adding functionality to computer keyboards by allowing them to selectively display alternative characters on each of the keyboard keys.
Increasing decreasing the cost of customizable keyboards by relying on backlighting lights already present within the keyboard.

The flowchart and block diagrams in the Figures illustrate the architecture, functionality, and operation of possible implementations of systems, methods, and apparatus according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Exemplary embodiments of the present disclosure are described largely in the context of a fully functional computer system for dynamic buffer selection in ethernet controllers. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will also recognize that, although some of the exemplary embodiments described in this specification are oriented to software installed and executing on computer hardware, nevertheless, alternative embodiments implemented as firmware or as hardware are well within the scope of the present disclosure.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. An apparatus comprising:
one or more backlit keyboard keys, a first of the one or more backlit keyboard keys including:
a socket comprising a light source; and
a keycap coupled to the socket, wherein the keycap includes:
a first color filter corresponding to a first character, wherein the first character is displayed on the keycap when a visible color of light emitted from the light source matches the first color filter; and
a second color filter corresponding to a second character, wherein the second character is displayed on the keycap when the visible color of the light emitted from the light source matches the second color filter.

2. The apparatus of claim 1, wherein the keycap further includes a third color filter corresponding to a third character, wherein the third character is displayed on the keycap when the visible color of the light emitted from the light source matches the third color filter.

3. The apparatus of claim 1, wherein the first character and the second character are spaced apart from each other on an exterior surface of the keycap.

4. The apparatus of claim 1, wherein the first character and the second character are superimposed on an exterior surface of the keycap.

5. The apparatus of claim 1, wherein the keycap is configured with four displayable characters that includes the first and second characters, the keycap further including:
a shield, wherein the first color filter and the second color filter are positioned on a first side of the shield; and
a third color filter and a fourth color filter, with corresponding third and fourth characters, positioned on a second side of the shield opposite from the first side.

6. The apparatus of claim 5, wherein the light source is a first light source and positioned on the first side of the shield, and wherein the socket further includes a second light source positioned on the second side of the shield.

7. The apparatus of claim 1, wherein the first character and the second character are each associated with a different alphabet.

8. A system comprising:
a keyboard comprising one or more backlit keyboard keys, wherein a first keyboard key of one or more backlit keyboard keys includes:
a socket comprising a light source; and
a keycap coupled to the socket, wherein the keycap includes:
a first color filter corresponding to a first character, wherein the first character is displayed on the keycap when a visible color of light emitted by the light source matches the first color filter; and
a second color filter corresponding to a second character, wherein the second character is displayed on the keycap when the visible color of the light emitted by the source matches the second color filter; and
a processor configured to receive a signal from the first keyboard key and recognize the signal as the first character when the visible color of light emitted by the light source matches the first color filter, and as the second character when the visible color of light emitted by the light source matches the second color filter.

9. The system of claim 8, wherein the keycap further includes a third color filter corresponding to a third character, wherein the third character is displayed on the keycap when the visible color of the light emitted from the light source matches the third color filter.

10. The system of claim 8, wherein the first character and the second character are spaced apart from one another on an exterior surface of the keycap.

11. The system of claim 8, wherein the first character and the second character are superimposed on an exterior surface of the keycap.

12. The system of claim 8, wherein the keycap is configured with four displayable characters that includes the first and second characters, the keycap further including:
a shield, wherein the first color filter and the second color filter are positioned on a first side of the shield; and
a third color filter and a fourth color filter, with corresponding third and fourth characters, positioned on a second side of the shield opposite from the first side.

13. The system of claim 12, wherein the light source is a first light source and positioned on the first side of the shield, and wherein the socket further includes a second light source positioned on the second side of the shield.

14. The system of claim 8, wherein the processor is external to the keyboard.

15. A method comprising:
receiving an input; and
changing a color of a light emitted from a light source backlighting a keyboard key from a first color to a second color in response to the input, the changing of the color of light resulting in a displayed character on the keyboard key being changed from a first character corresponding to the first color to a second character corresponding to the second color.

16. The method of claim 15, wherein receiving the input includes receiving at least one keypress corresponding to a keyboard shortcut.

17. The method of claim 15, wherein receiving the input includes receiving an indication that a software application has been triggered, and wherein the second color is determined based on the triggered software application.

18. The method of claim 15, wherein the keyboard key includes:
a socket comprising the light; and
a keycap coupled to the socket, wherein the keycap includes:
a first color filter of the first color and corresponding to the first character, wherein the first character is displayed on the keycap based on the color of the light matching the first color filter; and
a second color filter of the second color and corresponding to the second character, wherein the second character is displayed on the keycap based on the color of the light matching the second color filter.

19. The method of claim 15, wherein the input is a first input, and the method further comprises:
receiving a second input subsequent to the first input; and
changing the color of light emitted by the light source from the second color to the first color in response to the second input, the changing of the color of light emitted by the light source resulting in the displayed character being changed from the second character to the first character.

20. The method of claim 19, wherein the first character is a character of a first alphabet and the second character is a character of a second alphabet.
